(19) United States
(12) Patent Application Publication
(10) Pub. No.: US 2026/0056869 A1
(43) Pub. Date: Feb. 26, 2026

(54) INTELLIGENT MATRIX GENERATOR TO ARRANGE AND GENERATE TEST DATA SETS

(71) Applicant: SAP SE, Walldorf (DE)

(72) Inventors: VENKAT BHARGAV A S, BANGALORE (IN); AKSHATHA K B, BANGALORE (IN)

(21) Appl. No.: 18/814,181

(22) Filed: Aug. 23, 2024

(51) Int. Cl. G06F 11/36

(52) U.S. Cl. CPC G06F 11/3676

(57) ABSTRACT

A computer-implemented method comprises receiving a plurality of entries, each of the plurality of entries comprising a plurality of values, each of the plurality of values having an associated category of a plurality of categories, defining a plurality of combinations of categories, each of the plurality of combinations of categories comprising at least one of the categories of the plurality of categories, determining, for each of the plurality combination of categories, a first associated frequency of the received entries having values associated with the at least one of the categories of the respective combination of categories, generating a first matrix containing each of the plurality of combinations of categories and the first associated frequency, determining, for each of the plurality of combination of categories and for each category of each combination of the plurality of combinations of categories, a second associated frequency of values of the plurality of values having a particular value associated with each of the categories of the combination of categories, generating a second matrix having entries containing each of the combinations of categories and the values of the plurality of values having a highest second frequency, and providing the entries of the second matrix to a test entity to test an application.

### TECHNICAL FIELD

The present disclosure relates to application testing.

### BACKGROUND

Deployment of updates to applications that cause issues on the customer side demand quick solutions. The deployment of new fixes to solutions should be degradation-free, hassle-free, fast, and seamless. There is a need to ensure the quality of the deployment of new fixes to software solutions. Manual determination of test data that can be used to test applications is not practical as it is time and resource intensive.

### SUMMARY

In some embodiments, there is provided receiving a plurality of entries, each of the plurality of entries comprising a plurality of values, each of the plurality of values having an associated category of a plurality of categories; defining a plurality of combinations of categories, each of the plurality of combinations of categories comprising at least one of the categories of the plurality of categories; determining, for each of the plurality combination of categories, a first associated frequency of the received entries having values associated with the at least one of the categories of the respective combination of categories; generating a first matrix containing each of the plurality of combinations of categories and the first associated frequency; determining, for each of the plurality of combination of categories and for each category of each combination of the plurality of combinations of categories, a second associated frequency of values of the plurality of values having a particular value associated with each of the categories of the combination of categories; generating a second matrix having entries containing each of the combinations of categories and the values of the plurality of values having a highest second frequency; and providing the entries of the second matrix to a test entity to test an application.

In some variations, one or more features disclosed herein including one or more of the following features may be implemented as well. A priority may be associated with each of the associated frequencies. A highest priority may be associated with a highest frequency of the first associated frequencies. The second matrix may be appended with a third matrix containing a plurality of constant values. The priority may be determined based on a combination of categories and associated first frequencies received from a customer. A first instance of a redundant combination of categories and the values of the plurality of values having the highest second frequency may be removed from the second matrix, while maintaining a second instance of the redundant combination of categories and the values of the plurality of values having the highest second frequency. The plurality of entries may be a first plurality of entries and the plurality of values may be a first plurality of values. There may also be provided receiving a second plurality of entries, each of the second plurality of entries comprising a second plurality of values, each of the second plurality of values having an associated category of the plurality of categories; determining, for each of the plurality combination of categories, a third associated frequency of entries of the second plurality of entries having respective values associated with the at least one of the categories of the respective combination of categories; generating a third matrix containing each of the plurality of combinations of categories and the third associated frequency; determining, for each of the plurality of combination of categories and for each category of each combination of the plurality of combinations of categories, a fourth associated frequency of values of the second plurality of values having a particular value associated with each of the categories of the combination of categories; and/or generating a fourth matrix containing each of the combinations of categories and the values of the second plurality of values having a highest fourth frequency for the second plurality of entries and the highest second frequency for the first plurality of entries.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a block diagram of an example of a test data, in accordance with some example implementations of the current subject matter;

FIG. 2A illustrates a diagram of a process flow for the creation of a matrix containing a test data set for an application to be tested, in accordance with some example implementations of the current subject matter;

FIGS. 2B, 2C, and 2D depict examples of user interfaces, in accordance with some example implementations of the current subject matter; and

FIG. 3 illustrates a block diagram of another example of a system, in accordance with some example implementations of the current subject matter.

### DETAILED DESCRIPTION

Customers of software companies demand quick solutions to disruptions of applications. Delivery of solutions should be hassle-free and degradation-free. Manual testing of application updates and upgrades is time and resource intensive.

In some embodiments, one or more matrices may be generated, wherein the matrices contain test data for applications that can be used in testing applications before deployment of the application. For example, matrices containing test data may be generated to contain data used for application regression testing, end-to-end (E2E) regression testing, pre-upgrade testing of applications, post-upgrade testing of applications, update testing of applications, feature-based enablement, inbound qualification, and/or outbound qualification.

As customer-relevant test data sets can be created in internal systems, virtual realization of pre- and post-upgrade application testing and update testing is made possible in advance of upgrades and updates being made. Doing so allows for seamless updates and upgrades to be made more efficiently. The examples described herein may allow for flexible testing of an application. If issues with an application are raised, data sets for testing the application can be re-updated, improvised, and/or changed such that testing can be refined and repeat issues can be avoided. This may result in a drastic improvement in the quality of application testing and reduced resource usage (e.g., due in part to seamless updates and upgrades to applications, faster testing results, efficient visualization of post-upgrade testing internally, scalability, and/or reduction of manual test efforts).

To illustrate, a customer purchasing a notebook involves two parties—the customer (whose account is debited) and the seller (whose account if debited). The parties may each have an account associated a corresponding tax code. Further, the parties may each have an associated cost center to which the purchase is attributed. This transaction may use one or more applications to for example create a purchase order, a sales order, and/or to move funds between the appropriate accounts at different banks. Large companies may rely on these applications for millions of transactions annually. By generating test data sets containing, for example, the account, tax code information, and cost center information, upgrades or updates to the applications (which are used the transaction) can be tested.

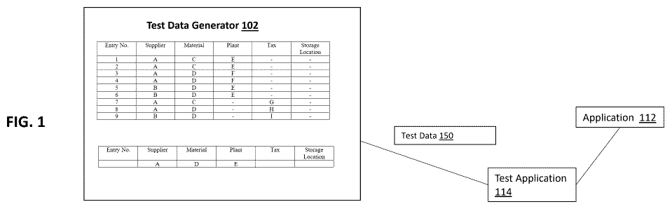

FIG. 1 depicts a diagram illustrating an example of a system 100 consistent with implementations of the current subject matter. The system may include a test data generator 102. The test data generator determines an intelligent matrix that can be used to generate test data 150. This test data can be used by a test application when testing an application 112. The test data 150 resembles or otherwise simulates realistic data that would be input to the application 112 by an entity that uses the application. By simulating this realistic test data, testing of the application 112 may require less resources (e.g., more rapid testing cycles reducing processing, compute, and network resources).

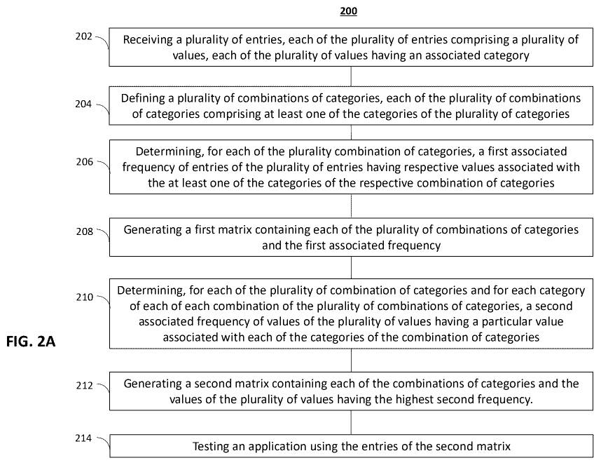

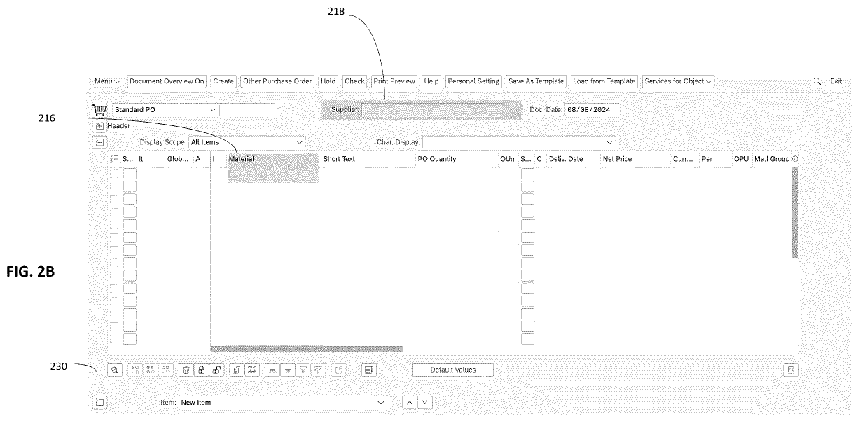

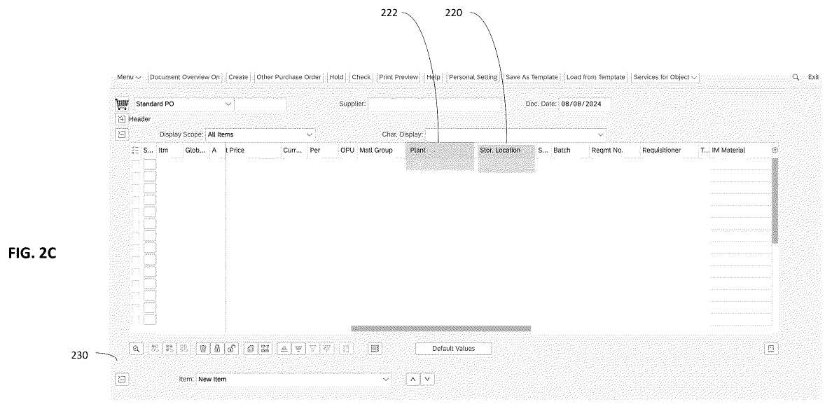

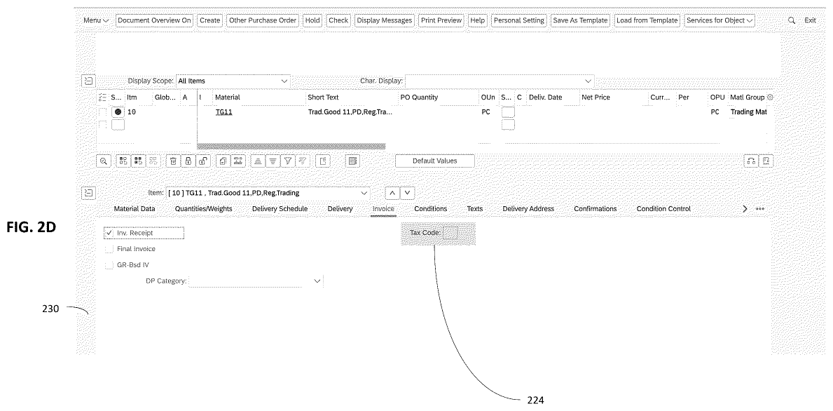

FIG. 2A depicts a process 200 (which may be a computer-implemented method) for generation of a test data set for an application. The description of FIG. 2A also refers to FIG. 1.

At 202, the process 200 may include receiving a plurality of entries, each of the plurality of entries comprising a plurality of values. For example, the test data generator 102 may receive a plurality of entries, and each of the plurality of entries may include a plurality of values. Moreover, the plurality of values may have an associated category. In the example of FIG. 2A, the application 112 (for which a test data set is generated) may be an application that is configured to create a purchase order, create a sales order, and/or to move funds between the appropriate accounts at different banks. In the case of the creating the purchase order application, the plurality of entries may include values that are associated with categories, such as a supplier, a material, a plant, a tax, a storage location, and/or other categories associated with the type of data that may be used during the execution of the creating the purchase order application.

At 204, the process 200 may include defining a plurality of combinations of categories, each of the plurality of combinations of categories may comprise at least one of the categories of the plurality of categories. For example, the test data generator 102 may be used to define the plurality of combinations of categories. For example, the first combination of categories may include the categories supplier, material, and plant; the second combination of categories may include the categories supplier, material, and tax; a third combination of categories may include the categories supplier, plant, and tax; the fourth combination of categories may include the categories supplier, material, and storage location; the fifth combination of categories may include the categories material, plant, and tax, although other combinations of categories (or quantities in each combination) may be defined as well.

To define the plurality of combinations, the test data generator 102 may be configured to receive input from a user device. For example, the test data generator 102 may be comprised on a user device such as a computer or other type of data processor (e.g., system 300). The input received at the user device defines (e.g., indicates) the plurality of combinations of categories.

For example, the plurality of combinations of categories may be defined based on the most frequently occurring combinations of categories in the received entries. To illustrate further, the plurality of combinations of categories may be defined as the top five most frequently occurring combinations of categories in the received entries. Moreover, the plurality of combinations of categories may be defined as for example the top ten most frequently occurring combinations of categories in the received entries. The plurality of combinations of categories may be defined as for example any number N of the most frequently occurring combinations of categories in the received entries. The number N of the most frequently occurring combinations of categories in the received entries can be selected and/or altered via system 100 (e.g., via a user device, such as test data generator 102) to yield test data sets with the desired robustness for the application being tested.

At 206, the process may include determining a first frequency of the received entries having values associated with the at least one of the categories of each of the respective combination of categories. As noted, the combinations of categories may be defined to use, for example, the ten most frequently occurring combinations of categories of the received entries as the defined combinations for the generation of test data. For example, the test data generator 102 may determine that there are six entries having values associated with the categories supplier, material, and plant. In this example, the test data generator may assign a first frequency of “six” to the combination of categories supplier, material, and plant. The test data generator 102 may further determine that there are three entries having values associated with the categories supplier, material, and tax, and assign a first frequency of “three” to the combination of categories supplier, material, and tax. The test data generator 102 may determine the frequency of entries having values associated with any particular combination of categories, and assign the appropriate frequency to that combination of categories.

At 208, the process may include generating a first matrix including each of the plurality of combinations of categories and the first associated frequency. Continuing with the previous example, the test data generator 102 may generate a matrix that has a frequency of “six” associated with the combination of categories comprising supplier, material, and plant. The test data generator 102 may further include in the matrix the frequency “three” associated with the combination of categories comprising supplier, material, and tax.

At 210, the process 200 may include determining, for each of the plurality of combination of categories and for each category of each of each combination of the plurality of combinations of categories, a second associated frequency of values of the plurality of values having a particular value associated with each of the categories of the combination of categories.

For example, the test data generator 102 may receive the nine entries as shown at Table 1 below. Based on the entries in Table 1 for example, the test data generator 102 may determine that, of the six entries having values associated with the combination of categories comprising supplier, material, and plant, four of the entries have associated with the supplier category a same first supplier value “A” and the two of the entries have associated with the supplier category a second supplier value “B” different from the first supplier value. In this example, the test data generator 102 may assign to the first supplier value a second frequency of “four” and may assign a second frequency of “two” to the second supplier value.

Given Table 1, for example, the test data generator 102 may determine that, of the six entries having values associated with the combination of categories comprising supplier, material, and plant, two of the entries have associated with the material category a first material value “C” and the remaining four entries have a same second material value “D”, different from the first material value. In this example, the test data generator 102 may assign to the first material value a second frequency of “two” and may similarly assign to the second material value a second frequency of “four”.

TABLE 1
First Matrix

| | | | | | Storage |
|---|---|---|---|---|---|
| Entry No. | Supplier | Material | Plant | Tax | Location |
| 1 | A | C | E | — | — |
| 2 | A | C | E | — | — |
| 3 | A | D | F | — | — |
| 4 | A | D | F | — | — |
| 5 | B | D | E | — | — |
| 6 | B | D | E | — | — |
| 7 | A | C | — | G | — |
| 8 | A | D | — | H | — |
| 9 | B | D | — | I | — |

Given Table 1 for example, the test data generator 102 may also determine that four of the six entries having values associated with supplier, material, and plant have associated with the plant category a first plant value “E” and that the remaining two entries having values associated with the supplier, material, and plant categories have associated with the plant category a second plant value “F”. The test data generator 102 may thus also assign a second frequency of “four” to the first plant value associated with the plant category and may similarly assign a second frequency of “two” to the second plant value associated with the plant category.

At 212, the process may include generating a second matrix, the entries of which contain each of the combinations of categories and the values of the plurality of values having the highest second frequency. For example, the test data generator 102 may generate a second matrix that associates with the categories supplier, material, and plant the first supplier value, the second material value, and the third tax value. Table 2 depicts an example of the second matrix.

TABLE 2
Second Matrix

| | | | | | |
|---|---|---|---|---|---|
| | | | | | Storage |
| Entry No. | Supplier | Material | Plant | Tax | Location |

| | | |
|---|---|---|
| A | D | E |

As shown, preparation of a matrix in accordance with the process 200 may result in a matrix entry (such as the values A, D, E, associated with, respectively, the supplier, material, and plant categories) that, while not being among the entries originally received by the test data generator (see, e.g., Table 1), is indicative of the statistics of the most frequently used values for each respective category. The constructed entries can serve as realistic test data sets, as they are based off of statistics of high frequency values. By considering all possible sets of fields used in an application (in the example of FIG. 2A, the creation of a purchase order), a list of test data sets can be generated with minimal input from an end user.

At 214, the process 200 may include providing the entries of the second matrix to a test entity to test an application. For example, the entries of the second matrix may be provided by the test data generator 102 to a test entity, such as test application 114 (which is configured to perform one or more tests using the entries) of the application 112.

An end user (e.g., an internal tester or a customer using the application) may initiate testing of the application (e.g., via the test data generator 102) using the entries of the second matrix generated according to process 200. FIGS. 2B, 2C, and 2D show examples of a user interface 230 for testing an application using the entries of the second matrix produced according to process 200. In the example of FIGS. 2B, 2C, and 2D, the second matrix generates data for testing an application that creates a purchase order. The data generated for testing the application that creates a purchase order contains values corresponding to the supplier, material, plant, storage location, and tax code categories.

The generated test data may be entered into the appropriate fields in the application 112 during for testing. For example, FIG. 2B shows highlighted fields material 216 and supplier 218 into which test data generated in the second matrix corresponding to the material and supplier fields may be entered. FIG. 2C similarly shows highlighted fields location 220 and plant 222 into which the data generated in the second matrix corresponding to the plant and storage location fields may be entered. FIG. 2D shows a highlighted field task code 224 into which the data generated in the second matrix corresponding to the tax code field may be entered.

The second matrix may, as noted, generate test data, such as test data 150, corresponding to any number of appropriate combinations of categories, and the combinations themselves may comprise any suitable categories. Accordingly, the user interface of FIGS. 2B-2D may be easily adapted to allow for entry of data corresponding to any possible combination of categories, and any possible categories.

In some implementations, some of these categories may be considered “mandatory” for the sake of generating these test data sets. For example, every test data set generated in accordance with embodiments described herein may be required to have values associated with the supplier, material, and plant categories, but need not have values associated with the tax and storage location categories. To create test data sets, it is helpful to have customer data. However, copying customer data into internal systems for test data set generation is tedious. Instead, it may be desirable to obtain a list of combinations of categories used by a customer for an application. On determining the combination of categories that a customer uses for the application, mandatory categories can be determined, and test data sets can be generated accordingly.

In some implementations, test data sets generated by internal systems, such as the test data generator 102 of FIG. 1, may be compared to data sets received from other sources, such as customer devices. Test data sets generated by internal systems may be updated or assigned a priority based on their resemblance to data sets received from the customer device.

In some implementations, a priority can be assigned to each combination. Particular values associated with each category can also be prioritized. Once a combination of categories is finalized, the most used values may be prioritized. In some implementations, a first of two test data sets generated may be assigned a higher priority than a second of the two test data sets if, for example, the first of the two data sets has a mandatory field with a value having a higher frequency than the value for the mandatory field for the second data set, even if the two data sets contain values across all categories of the combination of categories of the test data set that have an equal cumulative frequency.

In some implementations, a set of constant values can be appended or otherwise added to a generated test data set. Constant values may be, for example, a company code or a sales organization. Such constant values may be provided by a customer, and the inclusion thereof in a generated matrix can help to create a more realistic test data set. Any number of test data sets can be generated, and any number of the generated test data sets can be selected for running tests.

In some implementations, it may be desirable to create a test data set containing data relevant for two applications. For example, a first application may involve data used in creating a purchase order and a second may involve data used in creating a journal entry. A first matrix containing test data sets may be generated for the application related to purchase order creation, and a second matrix containing test data sets may be generated for the application relating to journal entry creation, in accordance with the exemplary method described by FIG. 2A.

For each of the first and second matrices generated, a priority may be assigned to a particular frequency of combinations of categories, as described above. A third resultant matrix that contains test data sets for both generation of a purchase order and a journal can then be generated that is associated with each of the priorities assigned to the frequencies of combinations of categories in the first and second matrices. For example, the third matrix may assign a first priority to the highest-frequency entries of the first matrix, and may associate the highest-frequency entries of the first matrix with the entries of the second matrix having a first, second, and third priority. In this way, the third matrix may contain a first entry associated with the highest-frequency entries of the first matrix and the highest-frequency entries of the second matrix, a second entry with the highest-frequency entries of the first matrix and the second-highest-frequency entries of the second matrix, and a third entry with the highest-frequency entries of the first matrix and the third-highest-frequency entries of the second matrix.

Priorities can be assigned to applications for inclusion in test data sets based on most frequently used applications by customers and applications for which the customers report the most issues. For example, a test data set may be generated that associates a highest priority with a first test data set from a list of combinations of categories most frequently used by a customer, a second priority with a first test data set from a list of combinations of categories most frequently associated with issues by customers, a third priority with a second test data set from a list of combinations of categories most frequently used by a customer, and a fourth priority with a second test data set from a list of combinations of categories most frequently associated with issues by customers.

A user may also define or alter a priority list. A priority list can be altered based on user-defined test data sets, user learnings, functional expertise, customer issue analysis and inferences, and internal incident learnings. In embodiments described herein, any priority list is possible, and such a priority list can be generated based on the particular application being tested. In all implementations described herein, redundant test data sets may be removed from the final matrices with generated test data sets. For example, if a generated matrix contains two of the same data sets, a first instance of the redundant data set may be removed and the second instance of the redundant data set may be maintained in the matrix so that the final matrix containing the data used for testing contains only unique data sets.

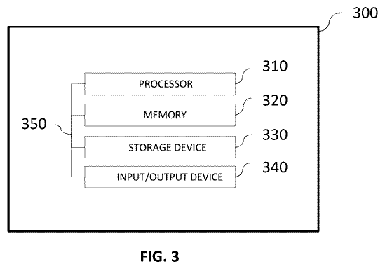

FIG. 3 depicts a diagram illustrating an example of a system 300 consistent with implementations of the current subject matter. In some implementations, the current subject matter may be configured to be implemented in a system 300. For example, the test data generator 102 may be implemented using the system 300. The system may include a processor 310, a memory 320, a storage device 330, and an input/output device 340. Each of the components (e.g., processor 310, memory 320, storage device 330 and input/output device 340) may be interconnected using a system bus 350. The processor 310 may be configured to process instructions for execution within the system 300. In some implementations, the processor 310 may be a single-threaded processor. In alternate implementations, the processor 310 may be a multi-threaded processor. The processor 310 may be further configured to process instructions stored in the memory 320 or on the storage device 330, including receiving or sending information through the input/output device 340. The memory 320 may store information within the system 100. In some implementations, the memory 320 may be a computer-readable medium. In alternate implementations, the memory 320 may be a volatile memory unit. In yet some implementations, the memory 320 may be a non-volatile memory unit. The storage device 330 may be capable of providing mass storage for the system 300. In some implementations, the storage device 330 may be a computer-readable medium. In alternate implementations, the storage device 130 may be a floppy disk device, a hard disk device, an optical disk device, a tape device, non-volatile solid-state memory, or any other type of storage device. The input/output device 340 may be configured to provide input/output operations for the system 300. In some implementations, the input/output device 340 may include a keyboard and/or pointing device. In alternate implementations, the input/output device 340 may include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid-state memory or a magnetic hard drive or any equivalent storage medium. The machine-readable medium can alternatively or additionally store such machine instructions in a transient manner, such as would a processor cache or other random-access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. A computer-implemented method, the method comprising:
receiving a plurality of entries, each of the plurality of entries comprising a plurality of values, each of the plurality of values having an associated category of a plurality of categories;
defining a plurality of combinations of categories, each of the plurality of combinations of categories comprising at least one of the categories of the plurality of categories;
determining, for each of the plurality combination of categories, a first associated frequency of the received entries having values associated with the at least one of the categories of the respective combination of categories;
generating a first matrix containing each of the plurality of combinations of categories and the first associated frequency;
determining, for each of the plurality of combination of categories and for each category of each combination of the plurality of combinations of categories, a second associated frequency of values of the plurality of values having a particular value associated with each of the categories of the combination of categories;
generating a second matrix having entries containing each of the combinations of categories and the values of the plurality of values having a highest second frequency; and
providing the entries of the second matrix to a test entity to test an application.

Example 2. The method of Example 1, further comprising, associating a priority with each of the associated frequencies.

Example 3. The method of any of Examples 1-2, wherein a highest priority is associated with a highest frequency of the first associated frequencies.

Example 4. The method of any of Examples 1-3, further comprising appending to the second matrix a third matrix containing a plurality of constant values.

Example 5. The method of any of Examples 1-4, further comprising determining the priority based on a combination of categories and associated first frequencies received from a customer.

Example 6. The method of any of Examples 1-5, further comprising removing from the second matrix a first instance of a redundant combination of categories and the values of the plurality of values having the highest second frequency, while maintaining a second instance of the redundant combination of categories and the values of the plurality of values having the highest second frequency.

Example 7. The method of any of Examples 1-6, wherein the plurality of entries is a first plurality of entries and the plurality of values is a first plurality of values, and further comprising:
receiving a second plurality of entries, each of the second plurality of entries comprising a second plurality of values, each of the second plurality of values having an associated category of the plurality of categories;
determining, for each of the plurality combination of categories, a third associated frequency of entries of the second plurality of entries having respective values associated with the at least one of the categories of the respective combination of categories;
generating a third matrix containing each of the plurality of combinations of categories and the third associated frequency;
determining, for each of the plurality of combination of categories and for each category of each combination of the plurality of combinations of categories, a fourth associated frequency of values of the second plurality of values having a particular value associated with each of the categories of the combination of categories; and
generating a fourth matrix containing each of the combinations of categories and the values of the second plurality of values having a highest fourth frequency for the second plurality of entries and the highest second frequency for the first plurality of entries.

Example 8. A system comprising:
at least one processor; and
at least one memory including instructions which when executed by the at least one processor causes operations comprising:
receiving a plurality of entries, each of the plurality of entries comprising a plurality of values, each of the plurality of values having an associated category of a plurality of categories;
defining a plurality of combinations of categories, each of the plurality of combinations of categories comprising at least one of the categories of the plurality of categories;
determining, for each of the plurality combination of categories, a first associated frequency of the received entries having values associated with the at least one of the categories of the respective combination of categories;
generating a first matrix containing each of the plurality of combinations of categories and the first associated frequency;
determining, for each of the plurality of combination of categories and for each category of each combination of the plurality of combinations of categories, a second associated frequency of values of the plurality of values having a particular value associated with each of the categories of the combination of categories;
generating a second matrix having entries containing each of the combinations of categories and the values of the plurality of values having a highest second frequency; and
providing the entries of the second matrix to a test entity to test an application.

Example 9. The system of Example 8, further comprising, associating a priority with each of the associated frequencies.

Example 10. The system of any of Examples 8-9, wherein a highest priority is associated with a highest frequency of the first associated frequencies.

Example 11. The system of any of Examples 8-10, further comprising appending to the second matrix a third matrix containing a plurality of constant values.

Example 12. The system of any of Examples 8-11, further comprising determining the priority based on a combination of categories and associated first frequencies received from a customer.

Example 13. The system of any of Examples 8-12 further comprising removing from the second matrix a first instance of a redundant combination of categories and the values of the plurality of values having the highest second frequency, while maintaining a second instance of the redundant combination of categories and the values of the plurality of values having the highest second frequency.

Example 14. The system of any of Examples 8-13, wherein the plurality of entries is a first plurality of entries and the plurality of values is a first plurality of values, and further comprising:
receiving a second plurality of entries, each of the second plurality of entries comprising a second plurality of values, each of the second plurality of values having an associated category of the plurality of categories;
determining, for each of the plurality combination of categories, a third associated frequency of entries of the second plurality of entries having respective values associated with the at least one of the categories of the respective combination of categories;
generating a third matrix containing each of the plurality of combinations of categories and the third associated frequency;
determining, for each of the plurality of combination of categories and for each category of each combination of the plurality of combinations of categories, a fourth associated frequency of values of the second plurality of values having a particular value associated with each of the categories of the combination of categories; and
generating a fourth matrix containing each of the combinations of categories and the values of the second plurality of values having a highest fourth frequency for the second plurality of entries and the highest second frequency for the first plurality of entries.

Example 15. A non-transitory computer-readable storage medium including instructions which when executed by at least one processor causes operations comprising:
receiving a plurality of entries, each of the plurality of entries comprising a plurality of values, each of the plurality of values having an associated category of a plurality of categories;
defining a plurality of combinations of categories, each of the plurality of combinations of categories comprising at least one of the categories of the plurality of categories;
determining, for each of the plurality combination of categories, a first associated frequency of the received entries having values associated with the at least one of the categories of the respective combination of categories;
generating a first matrix containing each of the plurality of combinations of categories and the first associated frequency;
determining, for each of the plurality of combination of categories and for each category of each combination of the plurality of combinations of categories, a second associated frequency of values of the plurality of values having a particular value associated with each of the categories of the combination of categories;
generating a second matrix having entries containing each of the combinations of categories and the values of the plurality of values having a highest second frequency; and
providing the entries of the second matrix to a test entity to test an application.

Example 16. The non-transitory computer-readable storage medium of Example 15, further comprising, associating a priority with each of the associated frequencies.

Example 17. The non-transitory computer-readable storage medium of any of Examples 15-16, wherein a highest priority is associated with a highest frequency of the first associated frequencies.

Example 18. The non-transitory computer-readable storage medium of any of Examples 15-17 further comprising appending to the second matrix a third matrix containing a plurality of constant values.

Example 19. The non-transitory computer-readable storage medium of any of Examples 15-18, wherein the plurality of entries is a first plurality of entries and the plurality of values is a first plurality of values, and further comprising:
receiving a second plurality of entries, each of the second plurality of entries comprising a second plurality of values, each of the second plurality of values having an associated category of the plurality of categories;
determining, for each of the plurality combination of categories, a third associated frequency of entries of the second plurality of entries having respective values associated with the at least one of the categories of the respective combination of categories;
generating a third matrix containing each of the plurality of combinations of categories and the third associated frequency;
determining, for each of the plurality of combination of categories and for each category of each combination of the plurality of combinations of categories, a fourth associated frequency of values of the second plurality of values having a particular value associated with each of the categories of the combination of categories; and
generating a fourth matrix containing each of the combinations of categories and the values of the second plurality of values having a highest fourth frequency for the second plurality of entries and the highest second frequency for the first plurality of entries.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, the method comprising:
receiving a plurality of entries, each of the plurality of entries comprising a plurality of values, each of the plurality of values having an associated category of a plurality of categories;
defining a plurality of combinations of categories, each of the plurality of combinations of categories comprising at least one of the categories of the plurality of categories;
determining, for each of the plurality of combinations of categories, a first associated frequency of the received plurality of entries having values associated with the at least one of the categories of the respective combination of categories;
generating a first matrix containing each of the plurality of combinations of categories and the first associated frequency;
determining, for each of the plurality of combinations of categories and for each category of each combination of the plurality of combinations of categories, a second associated frequency of values of the plurality of values having a particular value associated with each of the categories of the combination of categories;
generating a second matrix having entries containing each of the combinations of categories and the values of the plurality of values having a highest second frequency; and
providing the entries of the second matrix to a test entity to test an application.

2. The method of claim 1, further comprising associating a priority with each of the first associated frequencies.

3. The method of claim 2, wherein a highest priority is associated with a highest frequency of the first associated frequencies.

4. The method of claim 1, further comprising appending to the second matrix a third matrix containing a plurality of constant values.

5. The method of claim 2, further comprising determining the priority based on a combination of categories and associated first frequencies received from a customer.

6. The method of claim 1, further comprising removing from the second matrix a first instance of a redundant combination of categories and the values of the plurality of values having the highest second frequency, while maintaining a second instance of the redundant combination of categories and the values of the plurality of values having the highest second frequency.

7. The method of claim 1, wherein the plurality of entries is a first plurality of entries and the plurality of values is a first plurality of values, and further comprising:
receiving a second plurality of entries, each of the second plurality of entries comprising a second plurality of values, each of the second plurality of values having an associated category of the plurality of categories;
determining, for each of the plurality of combinations of categories, a third associated frequency of entries of the second plurality of entries having respective values associated with the at least one of the categories of the respective combination of categories;
generating a third matrix containing each of the plurality of combinations of categories and the third associated frequency;
determining, for each of the plurality of combinations of categories and for each category of each combination of the plurality of combinations of categories, a fourth associated frequency of values of the second plurality of values having a particular value associated with each of the categories of the combination of categories; and
generating a fourth matrix containing each of the combinations of categories and the values of the second plurality of values having a highest fourth frequency for the second plurality of entries and the highest second frequency for the first plurality of entries.

8. A system comprising:
at least one processor; and
at least one memory including instructions which when executed by the at least one processor causes operations comprising:
receiving a plurality of entries, each of the plurality of entries comprising a plurality of values, each of the plurality of values having an associated category of a plurality of categories;
defining a plurality of combinations of categories, each of the plurality of combinations of categories comprising at least one of the categories of the plurality of categories;
determining, for each of the plurality of combinations of categories, a first associated frequency of the received plurality of entries having values associated with the at least one of the categories of the respective combination of categories;
generating a first matrix containing each of the plurality of combinations of categories and the first associated frequency;
determining, for each of the plurality of combinations of categories and for each category of each combination of the plurality of combinations of categories, a second associated frequency of values of the plurality of values having a particular value associated with each of the categories of the combination of categories;
generating a second matrix having entries containing each of the combinations of categories and the values of the plurality of values having a highest second frequency; and
providing the entries of the second matrix to a test entity to test an application.

9. The system of claim 8, further comprising, associating a priority with each of the second associated frequencies.

10. The system of claim 9, wherein a highest priority is associated with a highest frequency of the first associated frequencies.

11. The system of claim 8, further comprising appending to the second matrix a third matrix containing a plurality of constant values.

12. The system of claim 9, further comprising determining the priority based on a combination of categories and associated first frequencies received from a customer.

13. The system of claim 8, further comprising removing from the second matrix a first instance of a redundant combination of categories and the values of the plurality of values having the highest second frequency, while maintaining a second instance of the redundant combination of categories and the values of the plurality of values having the highest second frequency.

14. The system of claim 8, wherein the plurality of entries is a first plurality of entries and the plurality of values is a first plurality of values, and further comprising:
receiving a second plurality of entries, each of the second plurality of entries comprising a second plurality of values, each of the second plurality of values having an associated category of the plurality of categories;
determining, for each of the plurality of combinations of categories, a third associated frequency of entries of the second plurality of entries having respective values associated with the at least one of the categories of the respective combination of categories;
generating a third matrix containing each of the plurality of combinations of categories and the third associated frequency;
determining, for each of the plurality of combinations of categories and for each category of each combination of the plurality of combinations of categories, a fourth associated frequency of values of the second plurality of values having a particular value associated with each of the categories of the combination of categories; and
generating a fourth matrix containing each of the combinations of categories and the values of the second plurality of values having a highest fourth frequency for the second plurality of entries and the highest second frequency for the first plurality of entries.

15. A non-transitory computer-readable storage medium including instructions which when executed by at least one processor causes operations comprising:
receiving a plurality of entries, each of the plurality of entries comprising a plurality of values, each of the plurality of values having an associated category of a plurality of categories;
defining a plurality of combinations of categories, each of the plurality of combinations of categories comprising at least one of the categories of the plurality of categories;
determining, for each of the plurality of combinations of categories, a first associated frequency of the received plurality of entries having values associated with the at least one of the categories of the respective combination of categories;
generating a first matrix containing each of the plurality of combinations of categories and the first associated frequency;
determining, for each of the plurality of combinations of categories and for each category of each combination of the plurality of combinations of categories, a second associated frequency of values of the plurality of values having a particular value associated with each of the categories of the combination of categories;
generating a second matrix having entries containing each of the combinations of categories and the values of the plurality of values having a highest second frequency; and
providing the entries of the second matrix to a test entity to test an application.

16. The non-transitory computer-readable storage medium of claim 15, further comprising, associating a priority with each of the first associated frequencies.

17. The non-transitory computer-readable storage medium of claim 16, wherein a highest priority is associated with a highest frequency of the first associated frequencies.

18. The non-transitory computer-readable storage medium of claim 15 further comprising appending to the second matrix a third matrix containing a plurality of constant values.

19. The non-transitory computer-readable storage medium of claim 15, wherein the plurality of entries is a first plurality of entries and the plurality of values is a first plurality of values, and further comprising:
receiving a second plurality of entries, each of the second plurality of entries comprising a second plurality of values, each of the second plurality of values having an associated category of the plurality of categories;
determining, for each of the plurality of combinations of categories, a third associated frequency of entries of the second plurality of entries having respective values associated with the at least one of the categories of the respective combination of categories;
generating a third matrix containing each of the plurality of combinations of categories and the third associated frequency;
determining, for each of the plurality of combinations of categories and for each category of each combination of the plurality of combinations of categories, a fourth associated frequency of values of the second plurality of values having a particular value associated with each of the categories of the combination of categories; and
generating a fourth matrix containing each of the combinations of categories and the values of the second plurality of values having a highest fourth frequency for the second plurality of entries and the highest second frequency for the first plurality of entries.
